(19) United States
(12) Patent Application Publication
(10) Pub. No.: US 2005/0227603 A1
(43) Pub. Date: Oct. 13, 2005

(54) IMPROVED SAUSAGE STUFFER

(76) Inventor: Krzysztof Stanuszek, Elma, NY (US)

Correspondence Address: SIMPSON & SIMPSON, PLLC, 5555 MAIN STREET, WILLIAMSVILLE, NY, 14221-5406, US

(21) Appl. No.: 10/708,997

(22) Filed: Apr. 6, 2004

(51) Int. Cl. A22C 11/02

(52) U.S. Cl. 452/42

(57) ABSTRACT

A device for manually stuffing sausage includes horn means having a horn inlet and a horn outlet. The device includes a piston means. The piston means is adapted to pass at least within the horn means from the horn inlet to the horn outlet. In a preferred embodiment, the horn inlet and the horn outlet have a substantially similar diameter; that is, the horn inlet and the horn outlet each have a diameter sufficiently large to allow the passage of the piston means therethrough. The device includes a retaining collar and a bell-shaped tube adapted to be releasably secured to the horn outlet. The bell-shaped tube has a tube inlet whose diameter is substantially similar to the horn outlet.

### FIELD OF THE INVENTION

The present invention relates generally to devices for processing foods, and more particularly, to an improved manually operated device for stuffing sausages and/or wieners.

### BACKGROUND OF THE INVENTION

The art of sausage making has existed for centuries and pre-dates written history. While today's sausages are readily and conveniently pre-made and purchased by consumers at the local supermarket, the first sausages were prepared primarily for preserving meats for use in times of scarcity. Hence, the term “sausage” is often attributed as being derived from early English, French and/or Latin terms for “salt”. The basic methods to prepare sausage have remained largely unchanged since the first sausages were made; choice cuts of meat are mixed with an amount of fat, seasonings and the like are added, and the mixture is forced into a casing to form a sausage link. While the basic methods for preparing sausages have remained unchanged, considerable technological advancements have occurred with regard to the mechanization and/or automation of sausage making. Such mechanization and automation of the sausage making process has allowed manufacturers to maintain the consistency and quality of their products. Indeed, perhaps millions of tons of consistently appearing and tasting sausages may be prepared by a single sausage factory, packaged, and sent to local supermarkets where it is readily purchased by consumers for consumption at barbeques, picnics or family celebrations.

Despite these technological advancements in the art of sausage making and/or the ability of the consumer to readily purchase pre-made sausages, hotdogs and the like, many choose to handcraft “heirloom” type sausages utilizing the “old” methods. In preparing sausages in this manner, the handcrafter is capable of controlling the types of meats used in the preparation of the sausage, the consistency and/or texture of the grind, and the seasonings and flavorings, etc. As a result, the handcrafter often, arguably, prepares far more unique and superior sausages than that which may be mass produced and purchased at the local supermarket.

When preparing handcrafted sausage according to the “old” methods, the handcrafter typically uses some type of hand-operated press, or hand-operated stuffer, to fill the sausage casings with the ground sausage mixture. There are several different types of hand-operated stuffer; some are cylindrical in appearance and resemble a common grease gun, some resemble wine presses having threaded spindles, and some are hopper-like and have hand-operated plungers and pistons.

There are several problems with the known hand-operated stuffers. For example, many have long handles that make them difficult to package, ship, and/or transport. The long handles also take up large amounts of space, making the stuffer difficult to store when not in use. While some have developed two-part handles, such handles do not include means for effectively locking the parts of the handle together. Thus, such stuffers are not particularly stable. Another problem associated with many known stuffers is that they can be difficult to operate and/or are not designed for ergonomic use. For example, grease gun and wine-press type stuffers can be awkward, difficult to operate, and/or slow to fill sausage casings. Additionally, many sausage stuffers, including known plunger/piston types do not provide sufficient clearance between the casings holder (typically a bell-shaped tube) and the work surface (a table). Most stuffers can also be difficult to hand or machine wash. Most importantly, however, most known sausage stuffers waste substantial portions of sausage mixture because they do not allow the plunger/piston to travel along the entire length of the sausage stuffer. Indeed, known plunger/piston type sausage stuffers comprise fixed tapered ends that do not allow the piston to travel therein (see FIG. 1).

Hence, there is a longfelt need for an improved hand-operated sausage stuffer that may be readily disassembled for efficient storage and/or transport, is easy to efficiently operate and clean, and which reduces or minimizes product waste.

### BRIEF SUMMARY OF THE INVENTION

A device for manually stuffing sausage comprises horn means including a horn inlet and a horn outlet. The device includes a piston means. The piston means is adapted to pass at least within the horn means from the horn inlet to the horn outlet. In a preferred embodiment, the horn inlet and the horn outlet have a substantially similar diameter; that is, the horn inlet and the horn outlet each have a diameter sufficiently large to allow the piston means to pass therethrough. The device includes a handle means, which in a preferred embodiment comprises two-parts which may be complementarily mated and secured to one another. The handle means is releasably pivotally securable to the horn means and is further adapted to releasably pivotally secure the piston means. The device includes a retaining collar and a bell-shaped tube. The retaining collar is adapted to be releasably secured to the horn outlet and secures the bell-shaped tube thereto. The bell-shaped tube includes a tube inlet and a tube outlet and the tube inlet has a diameter substantially similar to the horn outlet.

Thus, an object of the invention is to provide an improved device for stuffing sausage.

Another object of the invention is to provide an improved device for stuffing sausage that may be “broken down” for purposes of storing the device and/or packaging or shipping the device.

Still another object of the invention is to provide an improved device for stuffing sausage which is easier to operate;

Still yet, another object of the invention is to provide an improved device for stuffing sausage which may be easily cleaned.

A further object of the invention is to provide an improved device for stuffing sausage that produces less waste.

These and other objects, features and advantages of the present invention will become readily apparent to those having ordinary skill in the art upon reading the detailed description of the invention in view of the drawings and appended claims.

### BRIEF DESCRIPTION OF THE DRAWINGS

The nature and mode of operation of the present invention will now be more fully described in the following detailed description of the invention taken with the accompanying drawing figures, in which:

FIG. 1 is a perspective representation of a known hand-operated device for stuffing sausage;

FIG. 2 is a perspective view of a device for stuffing sausage according to the present invention;

FIG. 3 is a side view of a horn means according to the present invention;

FIG. 4 is a front view of a horn means according to the present invention;

FIG. 5 is a top view of a horn means according to the present invention;

FIG. 6 is side view of a first part of a two part locking handle according to the present invention;

FIG. 7 is a side view of a plunger/piston means according to the present invention;

FIG. 8 is a side view of a second part of a two part locking handle according to the present invention;

FIG. 9 is side view of a retaining collar according to the present invention;

FIG. 10 is a side view of a fastening means according to the present invention;

FIG. 11 is a side view of a bell-shaped tube according to the present invention;

FIG. 12 is a side view of a portion of a device for stuffing sausage according to the present invention, wherein the device is in the raised position and ready for plunging; and,

FIG. 13 is a side view of a portion of a device for stuffing sausage according to the present invention, wherein the device in the lowered position and stuffing a sausage casing.

### DETAILED DESCRIPTION OF THE INVENTION

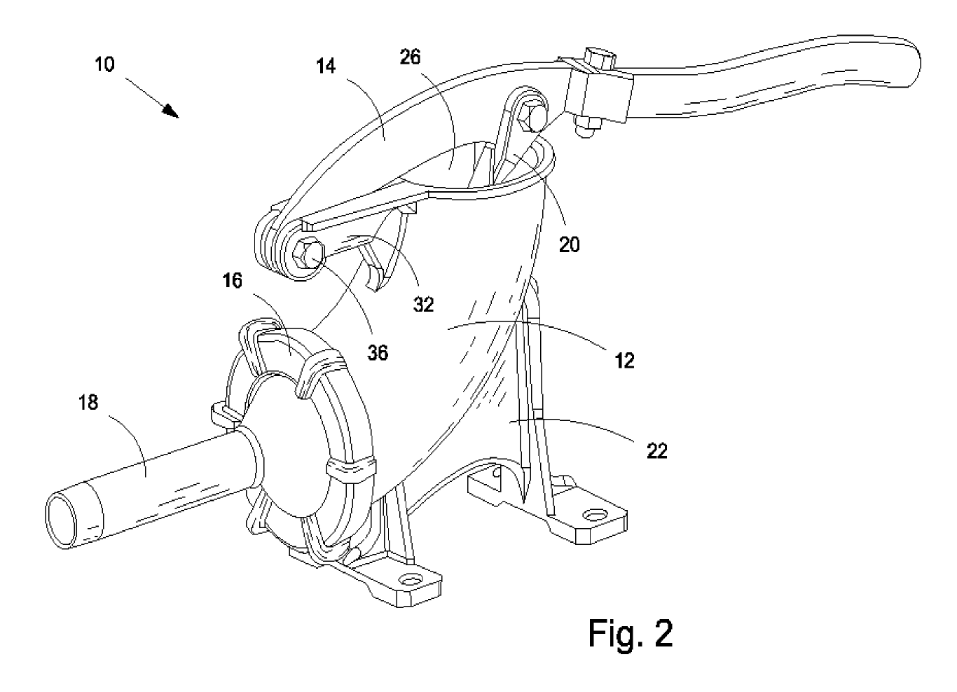

It should be appreciated at the outset that like drawing numbers on different drawing views identify identical structural elements of the invention. Additionally, while the present invention is described with respect to what is presently considered to be the preferred embodiment, it is to be understood that the invention as claimed is not limited to the disclosed embodiment. In the description that follows, the terms “up”, “down”, “forward”, “backward”, “left”, “right”, and their derivatives and corollaries, are to be interpreted from the perspective of one standing in front of the device of FIG. 2 such that bell-shaped tube 18 extends to their leftward side and handle 14 extends to their rightward side.

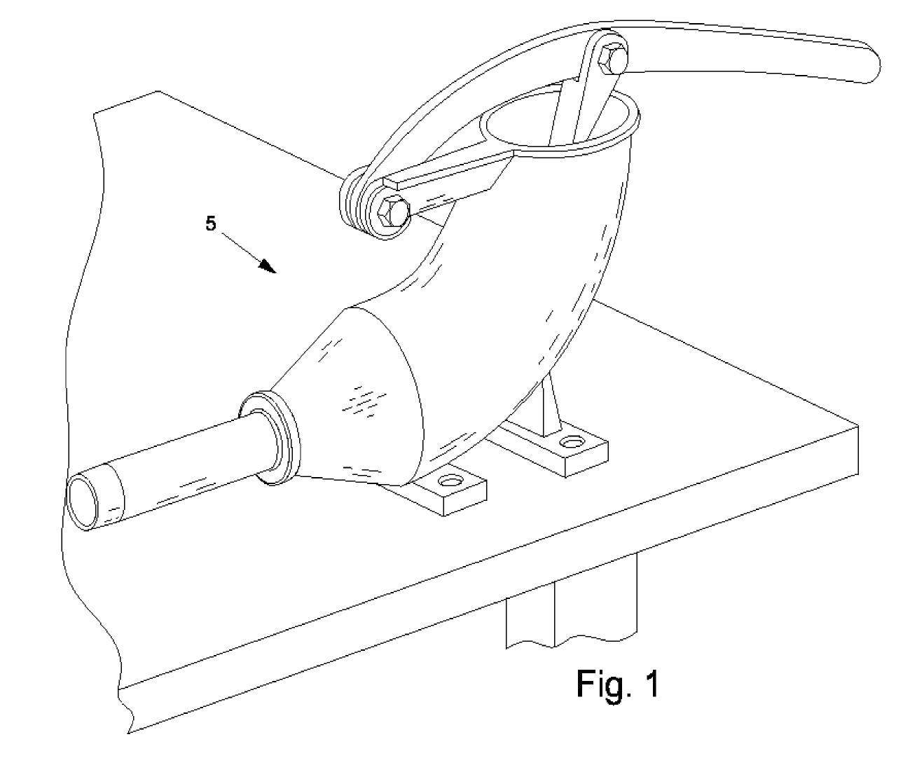

Adverting now to the figures, FIG. 1 illustrates known device 5 for stuffing sausage, wieners and the like. In FIG. 1 it is seen that the known device comprises a horn, or cylinder, that comprises a fixed tapered end. The fixed tapered end of the known device prevents the piston that slides within the horn, from traveling the full length of the horn, that is, from the horn inlet to the horn outlet. Thus, an amount of sausage mixture remains within the tapered end, which results in waste. Additionally, it is seen that the handle of known device does not comprise two-parts, such that the handle may be disassembled for storage and/or transport of the device. Finally, the legs of the known device are short such that the clearance between the bell-shaped tube and a working surface (a table top) is minimal, such that stuffing can be difficult.

Referring now to FIG. 2, sausage stuffer 10 according to the present invention broadly comprises horn 12, handle 14, retaining collar 16, bell-shaped tube 18, plunger/piston 20, and stand 22.

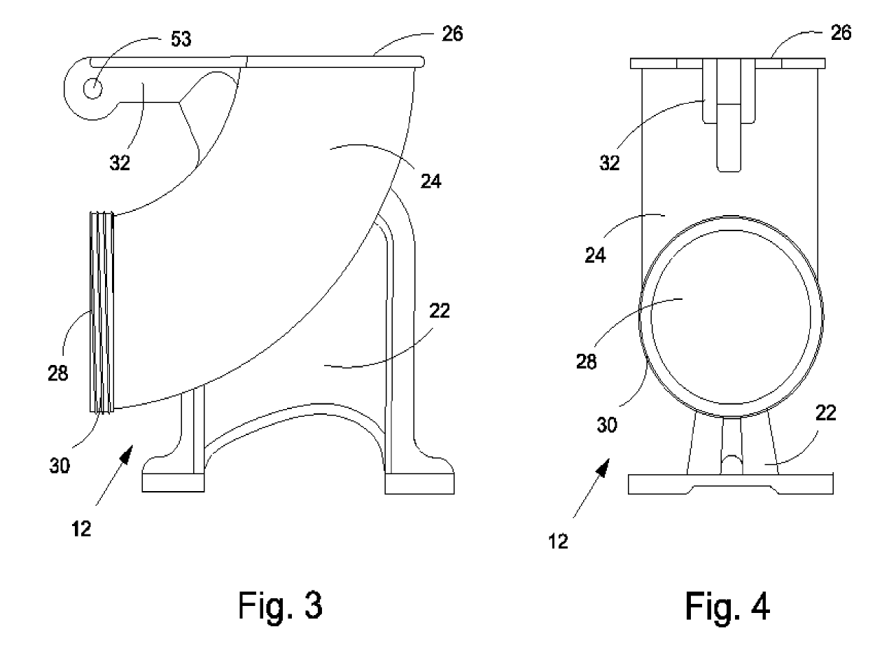

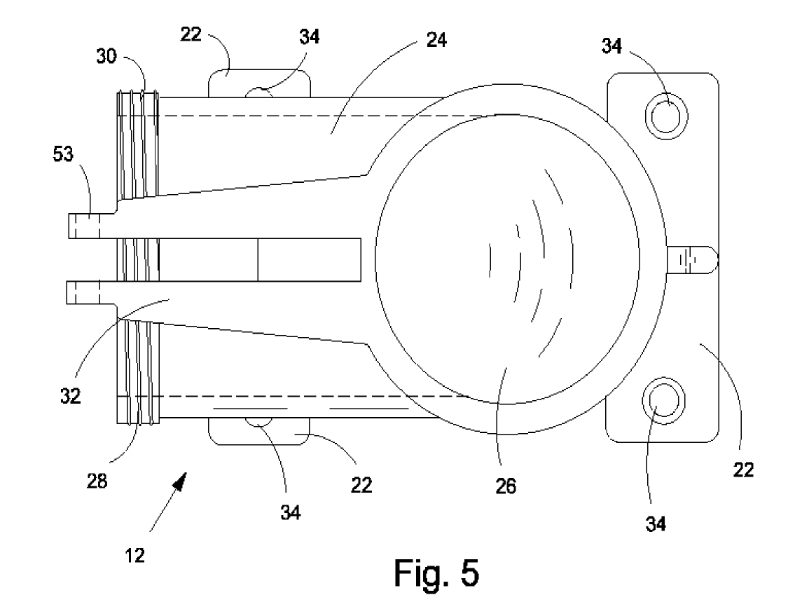

Referring now to FIGS. 3-11, in a preferred embodiment, horn 12 comprises an arcuate-shaped cylinder having inlet 26 and outlet 28. Inlet 26, outlet 28 and cylinder portion 24 have a circular cross-sectional shape and have equal inner diameters such that piston 56 (see FIG. 7) may be passed therethrough and travel along the entire length of the cylinder portion from inlet 26 to outlet 28. Inlet 26 may comprise a lipped portion, if desired, and outlet 28 may comprise threads 30, or like means for releasably fastening bell-shaped tube 18 thereto by means of retaining collar 16. It should appreciated by those having skill in the art that the leftward side of the cylindrical portion 24 proximate outlet 28 does not comprise a fixed funnel-like outlet structure as known device 5; that is, in a preferred embodiment the inner diameter of cylindrical portion 24 remains constant along its length. Because the present invention does not comprise a fixed funnel-like outlet structure, the piston of the present invention is free to travel along the entire length of cylinder portion 24, thereby reducing waste that remains in the funnel-like outlet structure of known devices. It should be further appreciated that the inner diameters of inlet 26, outlet 28 and cylinder portion 24 are also sufficiently large such that the inside of the horn may be hand cleaned by insertion of one's hand therein, if so desired. As can be seen in FIG. 1, known devices comprising funnel-like outer structures are not sufficiently large to allow hand cleaning.

Horn 12 further comprises handle pivot means 32 and stand 22. Handle pivot means 32 is provided for releasably pivotally securing handle 14 thereto. Appropriate means for pivotally securing the handle to the handle pivot means 32 include, but are not limited to: bolt 70 and nut 72 (see FIG. 10), which may be passed through through-bore 53. Stand 22 is also adapted to elevate horn 12 and bell-shaped tube 18 off of a working surface and comprise one or more extended legs therefor. As illustrated in FIG. 1, the legs of known devices are typically shorter and do not provide sufficient clearance between the bell-shaped tube and the working surface. As a result, known devices can be awkward, if not difficult, to operate. The legs of stand 22 may also comprise feet for increasing the stability to the device. The feet of the stand may comprise through-bores 34 for passing bolts 70 (see FIG. 10) therethrough such that the device may be releasably secured to a work surface. Other means, such as clamps, may also be utilized to secure the device to a work surface.

In a particularly preferred embodiment, the sausage stuffer and its various associated components are fabricated from stainless steel such that the device may resist corrosion and/or may be hand or machine washed. Of course, other corrosive resistant metals may be utilized, particularly those having the ability to retain coolness for extended periods of time as is generally required when manufacturing sausage. Finally, it should be appreciated by those having ordinary skill in the art that while a cylindrical horn having a circular cross-section is described herein, the horn and/or piston of the present invention may comprise other complementary cross-sectional shapes as may be desired; for example, the horn and piston may be oval, arcuate, or polygonal in shape, or comprise combinations thereof. Additionally, the feet of the device may include rubber boots such that device may be further prevented from sliding on a work surface when it is not bolted or clamped thereto.

Referring now to FIGS. 2, 6-8, handle 14 of the present invention is provided for pushing a sausage mixture through cylinder portion 24 such that the sausage mixture may be expelled through and out the bell-shaped tube 18 and into a sausage casing secured thereon. In a preferred embodiment, handle 14 comprises a two-part assembly such that the device may be easily packaged, stored when not in use, or transported.

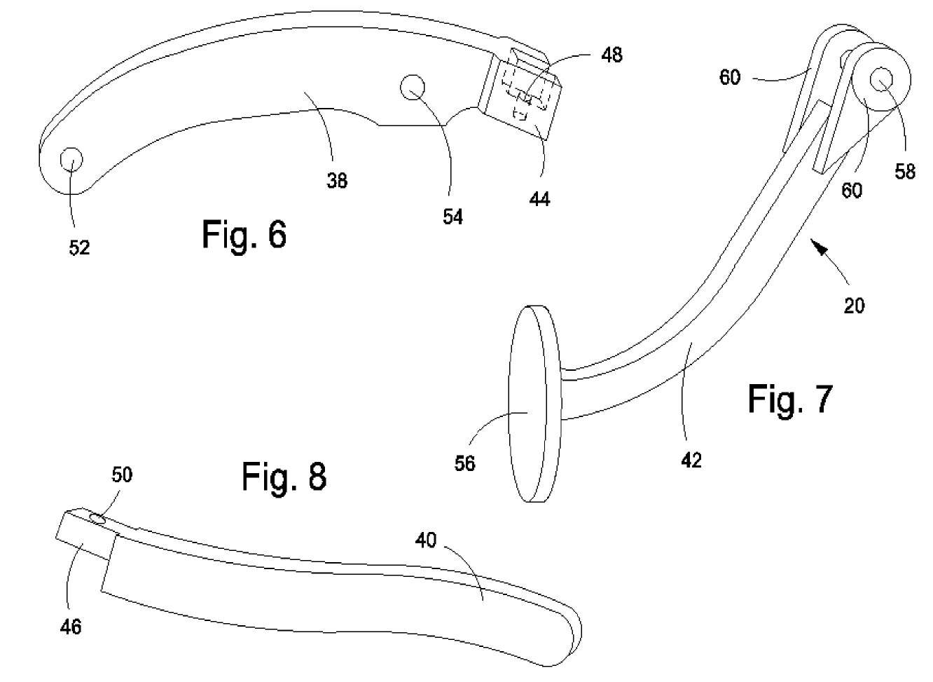

As illustrated more clearly in FIGS. 6 and 8, handle 14 comprises handle first part 38 and handle second part 40. Handle first part 38 comprises through-bore 52 disposed at one end thereof for pivotally releasably securing the handle to handle pivot means 32. Handle first part 38 of the handle may be secured to the handle pivot means 32 by an appropriate fastener, for example bolt 70 and nut 72 (see FIG. 10). Located at the other end of the handle first part 38, opposite through-bore 52, is female releasable locking means 44. Female releasable locking means 44 is provided for releasably locking handle first part 38 to handle second part 40. Female releasable locking means 44 is substantially U-shaped in appearance and comprises a recess. The recess includes a lower abutment that includes through-bore 48. Disposed between through-bore 52 and female releasable locking means 44 of the handle first part is through-bore 54. Through-bore 54 is provided for releasably pivotally securing plunger/piston 20 thereto (See FIG. 7) such that the piston/plunger may travel within the arcuate cylinder of the horn.

As shown more clearly in FIG. 8, handle second part 40 is provided for serving as that portion of the handle which is grasped by the user to drive the plunger/piston 20 of the device. Handle second part 40 comprises male releasable locking means 46, which comprises a tongued portion. The tongued portion of male releasable locking means 46 comprises through-bore 50. The tongued portion of male releasable locking means 48 is adapted for complementary mating fit with the recess of female releasable locking means 44. Additionally through-bores 44 and 50 are configured to align with one another when the handle first part is mated with the handle second part such that the two-parts may be secured to one another by means of bolt 70 and nut 72 (see FIGS. 1 and 10). Arranged in this manner, movement between the handle first part and the handle second part is virtually eliminated when compared with other handles that do not comprise complementary locking means.

Referring now to FIGS. 2, 3 and 7, plunger/piston 20 is provided for forcing an amount of sausage mixture through the cylinder portion. Plunger/piston 20 generally comprises rod portion 42, piston 56, through-bores 58 and hubs 60. As illustrated in FIGS. 2 and 7, plunger/piston 20 is adapted to be releasably pivotally secured to handle 14 via through-bore 54 of handle 14 and through-bores 58 of hubs 60. Hubs 60 are disposed on that end of piston/plunger 20 opposite piston 56 and form a forked structure such that handle first part 14 may be slidably received between the two hubs 60. Hubs 60 secure the plunger/piston 20 by means of bolts 70 and nuts 72 (see FIG. 10), or other appropriate means, and allow the plunger/piston 20 to pivot with respect to handle 14 during sausage making operations. Rod portion 42 is illustrated as being arcuately shaped to correspond to the arcuate shape of horn 12. The arcuate shape of rod portion 42 allows piston 56 to effectively slide within the cylinder along its entire length. In a preferred embodiment, piston 56 travels from above inlet 26, down through the cylinder portion, and at least to outlet 28 of the cylinder; plunger/piton may be adapted such that piston 56 may pass beyond outlet 28. In a preferred embodiment, piston 56 comprises a non-corrosive stainless steel and has a diameter that is acutely smaller than that of inlet 26, outlet 28, and cylinder 24, such that the piston may pass the inlet and the outlet thresholds and along the entire length of the cylinder portion. The piston may be adapted to comprise a rubber gasket, or seal, disposed about its circumference, such that the cylinder portion diameter could be configured to differ along it's length. It should be appreciated by those having ordinary skill in the art that the ability to remove the handle from the horn, disassemble the handle into two parts, and the ability to remove the piston/plunger 20 from the handle, allows the present invention to be broken-down for more convenient packing, shipping, cleaning and/or storage of the device.

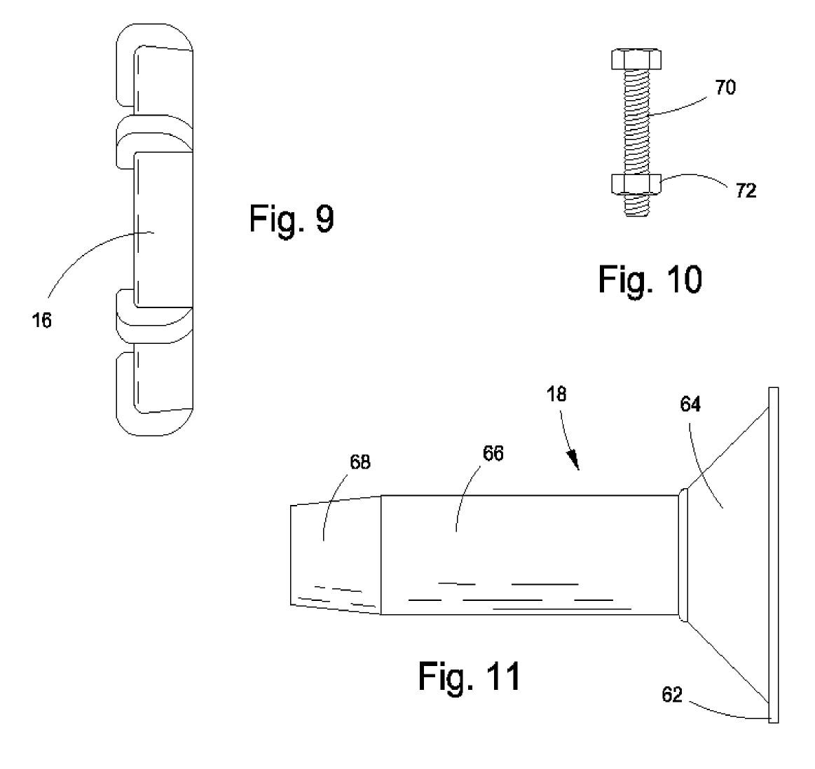

Referring now to FIGS. 9 and 11, bell-shaped tube 18 is provided for securing sausage casings thereon for stuffing purposes. In a preferred embodiment, bell-shaped tube 18 comprises annular ring portion 62, bell portion 64, extended tube portion 66, and tapered end 68. Annular ring 62 of the bell-shaped tube is adapted to be releasably secured to horn 12 proximate outlet 28 by means of retaining collar 16. Retaining collar 16 comprises an annular flange (not shown), which fits about annular ring 62 and applies a pressure thereto when the retaining collar is secured upon the horn, for example, by means of threading (not shown) that is complementary to threading 30 of the cylinder portion. Other means may be utilized to secure retaining collar 16 and bell-shaped tube 18 to the horn 12, if desired. Bell portion 64 is provided to funnel a sausage mixture into the extended tube portion and further serves to mix and emulsify the sausage mixture prior to stuffing. Extended tube portion 66 is provided for filling sausage casings and secures the sausage casings thereon. Tapered end 68 is provided so that the sausage casings may be easily loaded onto the extended tube portion. It should be appreciated by those having ordinary skill in the art that while a bell-shaped tube having a circular cross section is disclosed herein, other shaped and cross-sectional shaped tubes may be substituted as desired.

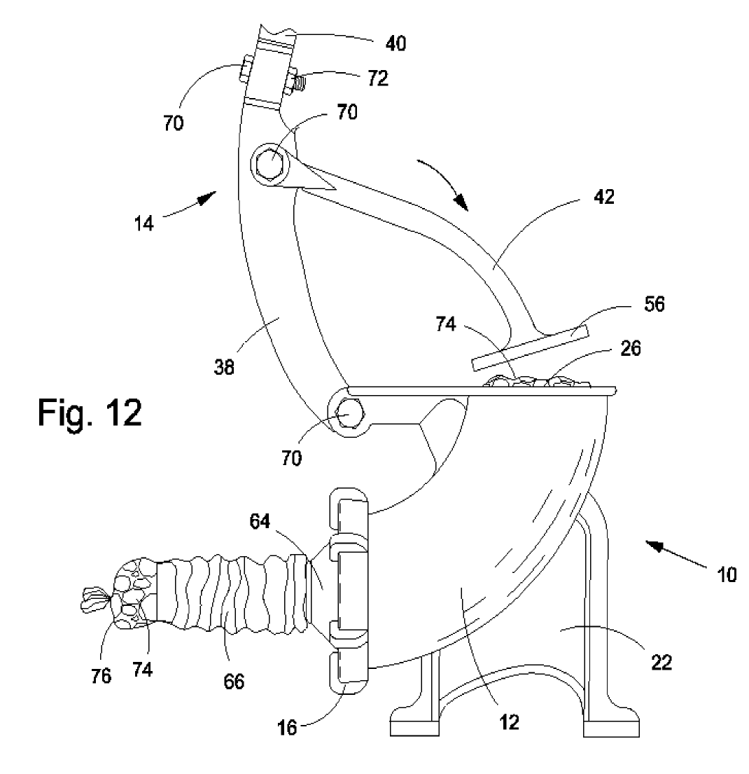

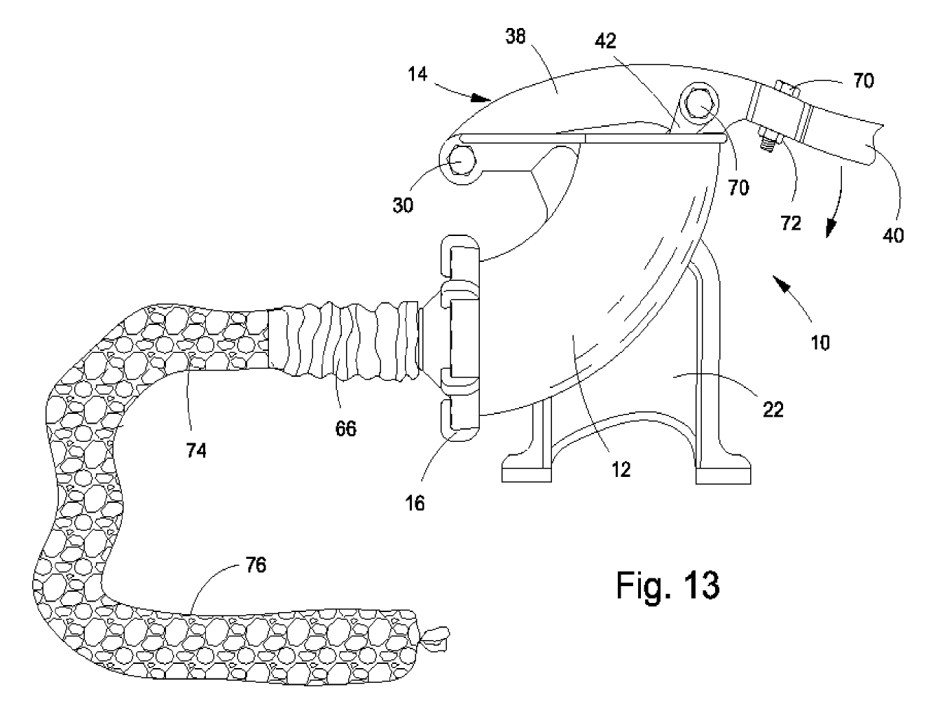

Referring now to FIGS. 12 and 13, a sausage stuffer according to the present invention may be utilized in the following manner. First, the various disassembled components of the invention are assembled to resemble the device shown in FIGS. 2, 12, and 13. Upon completion thereof, the device is cooled to an appropriate temperature for sausage stuffing to prevent spoilage and/or contamination. The device is then secured to a working surface and an amount of sausage casings 76 may be secured upon extended tube portion 66 of the bell-shaped tube. The plunger/piston 20 may then be raised by means of hand operation of handle 14. An amount of sausage mixture 74 is then loaded into inlet 26 of horn 12. Operation of handle 14 in the direction of the arrow of FIG. 12 causes piston 56 to force the sausage mixture down through the cylinder portion of the horn and into the bell-shaped tube. Sausage mixture 74 is further emulsified as it passes through bell portion 64 of the bell-shaped tube and eventually begins filling sausage casings 76 held thereon as shown in FIG. 13. Piston 56 continues to travel along the entire length of cylinder portion 24 until it reaches the lowermost limit thereof; that is, piston 56 may abut the annular flange (not shown) of the retaining collar, the annular ring of the bell-shaped tube and/or the handle may reach the maximum lower limit as shown in FIG. 13. To continue filling operations, one merely raises the handle, adds additional sausage mixture to the cylinder portion 24, and then lowers the handle. Consequently, it is seen that the sausage stuffer of the present invention is adapted to be more readily disassembled for more convenient packing, transport or storage purposes, allows for more convenient and more efficient sausage stuffing and cleanup, and reduces the amount of waste produced when compared with known devices.

Thus, it is seen that the objects of the present invention are efficiently obtained, although modifications and changes to the invention should be readily apparent to those having ordinary skill in the art, which modifications are intended to be within the spirit and scope of the invention as claimed.

1. A device for manually stuffing sausage comprising:
horn means comprising a horn inlet and a horn outlet,
piston means; and,
a bell-shaped tube;
said horn inlet with a first diameter and said horn outlet with a second diameter substantially similar to said first diameter, said piston means adapted to pass at least within said horn means from said horn inlet to said horn outlets and said horn outlet configured for receiving said bell-shaped tube.

2. The device of claim 1 wherein said horn inlet and said horn outlet have substantially similar diameters and said piston means is capable of slidable movement therebetween.

3. The device of claim 1 wherein said horn outlet further comprises means for releasably securing said bell-shaped tube and a retaining collar thereto.

4. The device of claim 3 wherein said retaining collar is operatively arranged to secure said bell-shaped tube, said bell-shaped tube comprising a tube inlet and a tube outlet, said tube inlet having a diameter substantially similar to said horn outlet.

5. The device of claim 1 further comprising a two-part handle and means for releasably pivotally securing said two part handle to said horn means.

6. The device of claim 5 wherein a first part and a second part of said two part handle are adapted for releasable complementary mate with one another such that said first part may be locked to said second part.

7. The device of claim 6 wherein said first part comprises means for releasably pivotally securing said handle to said horn means and means for releasably pivotally securing a piston means thereto.

8. The device of claim 7 wherein said piston means is capable of slidable movement within said horn means and between said horn inlet and said horn outlet.

9. The device of claim 1 further comprising mounting means for elevating said horn above a work surface.

10. The device of claim 1 wherein said horn means is arcuate.

11. A device for manually stuffing sausage comprising:
arcuate horn means comprising a horn inlet and a horn outlet,
piston means, said piston means adapted to pass at least within said horn means from said horn inlet to said horn outlet;
a retaining collar; and,
a bell-shaped tube,
said horn inlet with a first diameter and said horn outlet with a second diameter substantially similar to said first diameter, said retaining collar adapted to be releasably secured to said horn outlet, said retaining collar operatively arranged to secure said bell-shaped tube proximate said horn outlet, said bell-shaped tube comprising a tube inlet and a tube outlet, said tube inlet having a third diameter substantially similar to said second diameter.

12. The device of claim 11 further comprising a two-part handle and means for releasably pivotally securing said two part handle to said arcuate horn means.

13. The device of claim 12 wherein a first part and a second part of said two part handle are adapted for releasable complementary mate with one another such that said first part may be locked to said second part.

14. The device of claim 13 wherein said first part comprises means for releasably pivotally securing said handle to said arcuate horn means and means for releasably pivotally securing said piston means.

15. The device of claim 14 wherein said piston means is arranged for slidable movement along the entire length of said arcuate horn means.

16. The device of claim 15 further comprising mounting means for elevating said arcuate horn above a work surface.

17. The device of claim 11 wherein said horn inlet has a diameter substantially equal to that of said horn outlet.

18. A device for manually stuffing sausage comprising:
horn means comprising a horn inlet and a horn outlet;
handle means comprising a piston means, said piston means adapted to pass at least within said horn means from said horn inlet to said horn outlet;
a retaining collar; and,
said horn inlet with a first diameter and said horn outlet with a second diameter substantially similar to said first diameter a bell-shaped tube, said retaining collar adapted to be releasably secured to said horn outlet, said retaining collar operatively arranged to secure said bell-shaped tube proximate said horn outlet, said bell-shaped tube comprising a tube inlet and a tube outlet, said tube inlet having a third diameter substantially similar to said second diameter.
